(19) United States
(12) Patent Application Publication
(10) Pub. No.: US 2007/0005683 A1
(43) Pub. Date: Jan. 4, 2007

(54) Cost-based community feedback

(76) Inventor: Pierre Omidyar, Henderson, NV (US)

Correspondence Address: Omidyar Network Commions LLC, 1881 Broadway, sls, 200, Redwood, CA, 94083, US

(21) Appl. No.: 11/174,280

(22) Filed: Jul. 1, 2005

(51) Int. Cl. G06F 15/16

(52) U.S. Cl. 709/203

(57) ABSTRACT

Feedback is used as a value metric for members of and content in an online community. Members have bank units to use in the community to perform activities and to provide feedback about other members and the content they produce. Certain activities in the community have associated costs, which a user must be able to afford in order to participate. Because bank units are limited in supply, they acquire value within the community. Members therefore have an incentive both to spend their bank units judiciously and to act in such a way as to earn more units for themselves.

### BACKGROUND OF THE INVENTION

1. Field of the Invention

The present invention is directed in general to a cost-based feedback mechanism for online communities. In particular, the present invention encourages good user behavior by rewarding users who are well-respected by the community and who are active participants in the community with credits useable towards further participation in the community.

2. Description of Background Art

Online communities provide participants an opportunity to exchange ideas and information about topics of mutual interest. For example, communities exist for the purpose of online auctions, discussion of scientific research, swapping furniture, finding apartments, and the like. The online communities eBay, WebMD, and Craigslist are some of the many that provide subsets of these functions.

Conventional online communities suffer from some drawbacks, however. First, to varying degrees they require policing by operators of the community or their designees. Objectionable content is often removed after other members complain to those in charge, or after it is discovered by the operators themselves. Frequent violators of the community's rules or terms of service are typically banned from the site. This policing operation can be labor-intensive, and requires certain value judgments to be made by the operators of the community.

Some online communities provide members with the ability to rate some content as useful or not. For example, many communities dedicated to providing do-it-yourself help to members include a voting button next to each article asking members to indicate whether the article was helpful to them. Other communities, such as eBay, invite members to provide feedback on participants to a transaction. These feedback opportunities in conventional communities suffer from a common drawback-providing feedback has no associated cost. A first member can therefore give positive feedback to a second member, a third member, a fourth member, and so on, without consequence to the first member. While not completely eliminating the utility of the feedback, such a method clearly dilutes the value of positive (or negative) feedback.

Accordingly, what is needed is a system and method for providing feedback in online communities that enables a more useful measure of content value, allowing the community to manage itself and reducing the need for community overseers to monitor the community individually.

### SUMMARY OF THE INVENTION

The present invention enables a community in which feedback is used as a value metric for members and content. Each member of the community has an initial supply, e.g., 10, of “bank units”—credits that can be spent in the community to perform activities and to provide feedback about other members and the content they produce—discussions, groups, etc., as described more fully below. Certain activities in the community have associated costs—a user must have at least the minimum number of bank units available for an activity or else the user cannot perform the activity. Because bank units are limited in supply, they acquire value within the community. Members therefore have an incentive both to spend their bank units judiciously and to act in such a way as to earn more units for themselves.

According to the present invention, members earn bank units both by gaining the respect of others, i.e. having increasing feedback scores, and by participating in the community. Participation in a preferred embodiment means creating content for the community, e.g., creating or participating in discussions, contributing to workspaces, and the like. Therefore, members who participate to the fullest extent in the community and who earn feedback points from others end up with the greatest number of bank units. Conversely, those members who “lurk” from the sidelines instead of participating will receive few or no bank units for participation; those who earn disdain of their fellow community members will receive either low positive feedback scores, or even negative feedback scores. In one embodiment, as feedback scores for a member get lower and lower, the member loses his ability to participate in the community, ultimately leading to a total loss of ability to participate significantly in the community.

Feedback can be assigned to members or to items, allowing the creators and the contents to be rated distinctly. Feedback given to content is not reflected in the score of the content's creator and the reverse holds true as well: feedback given to users is not reflected in the score of the items created by said user.

A system in accordance with an embodiment of the present invention includes a feedback engine for determining when feedback scores are to be incremented or decremented and for determining whether members have sufficient bank units to perform requested actions. A bank unit module is responsible for incrementing and decrementing a user's bank when requested by the feedback engine. A feedback score module increments and decrements feedback scores of content items and other members as requested by the feedback engine. A member database stores user records including feedback scores and bank unit amounts for each user, and an item database stores item records including feedback scores for each item.

### BRIEF DESCRIPTION OF THE DRAWINGS

FIG. 1 is a block diagram of the a system for providing feedback in accordance with an embodiment of the present invention.

FIG. 2 illustrates an online community in accordance with an embodiment of the present invention.

FIG. 3 illustrates an example of a group record in accordance with an embodiment of the present invention.

FIG. 4 illustrates an example of a user record in accordance with an embodiment of the present invention.

FIG. 5 illustrates an example of an item record in accordance with an embodiment of the present invention.

FIG. 6 is a diagram illustrating how bank units are earned and spent in accordance with an embodiment of the present invention.

FIG. 7 is a flowchart illustrating how credit is added to a user's bank in accordance with an embodiment of the present invention.

FIG. 8 is a flowchart illustrating a process for giving feedback in accordance with an embodiment of the present invention.

FIG. 9 illustrates a method for processing activity costs in accordance with an embodiment of the present invention.

### DETAILED DESCRIPTION OF THE PREFERRED EMBODIMENTS

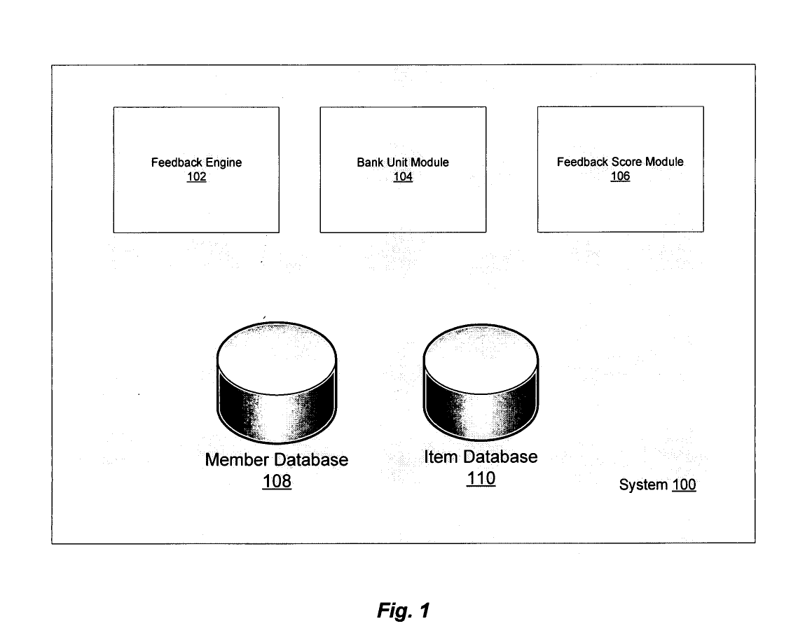

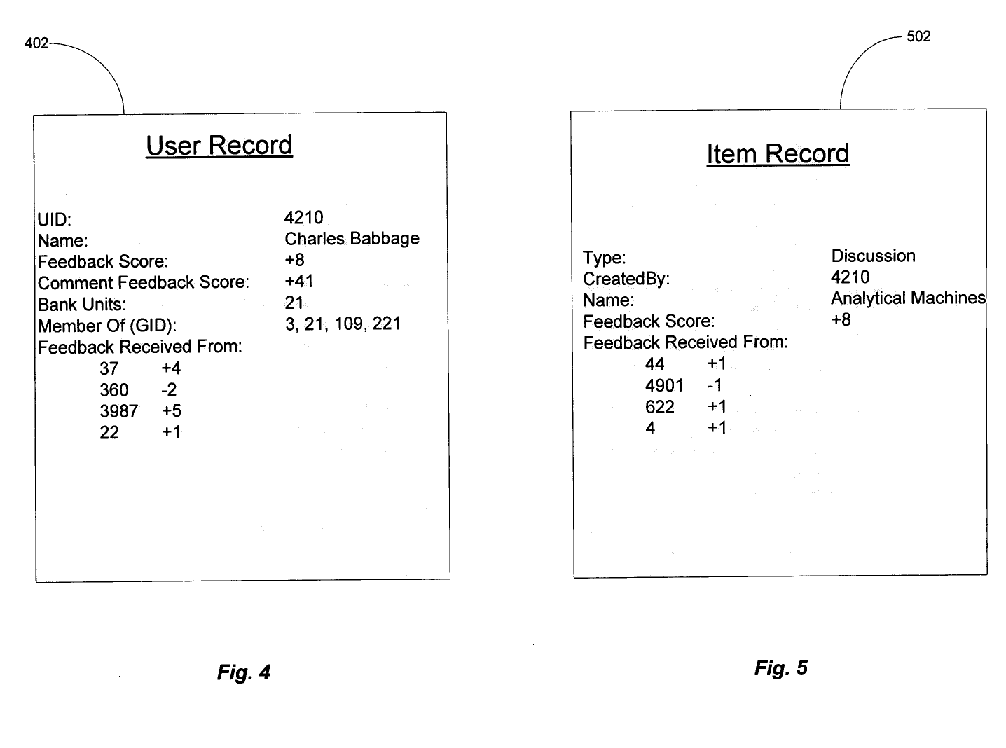

Referring now to FIG. 1, there is shown a block diagram of a system 100 for providing feedback in accordance with an embodiment of the present invention. System 100 includes a feedback engine 102, bank unit module 104, feedback score module 106, member database 108, and item database 110. Feedback engine 102 determines when feedback scores are to be incremented or decremented and whether members have sufficient bank units to perform requested actions. Bank unit module 104 maintains the bank units in each member's account, incrementing or decrementing the units as directed by feedback engine 102. Feedback score module 106 maintains a record of the number of feedback points each user has, increment and decrementing the feedback count for the user as requested by feedback engine 102. The feedback engine 102, bank unit module 104 and feedback score module 106 are described further below. Member database 108 stores information for each user of system 100, as illustrated more fully below with respect to FIG. 4. Item database 110 stores items such as discussions, comments, and the like that make up the content of system 100, illustrated further by FIG. 5.

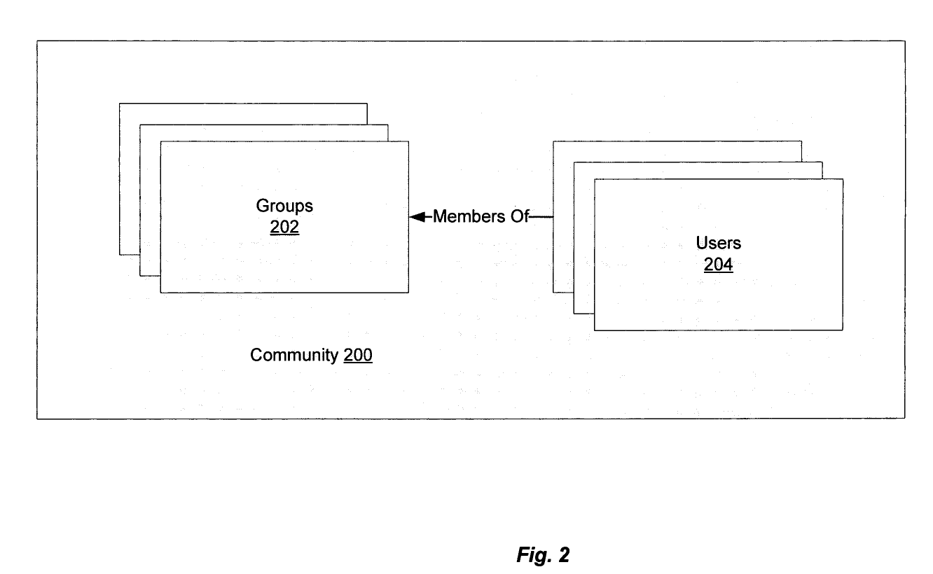

FIG. 2 illustrates an online community 200 in accordance with an embodiment of the present invention. Online community 200 includes a plurality of users 204 and a plurality of groups 202. As illustrated in FIG. 2, users 204 may be members of one or more groups 202. In one embodiment, a user 204 need not be a member of any group 202 in order to still be a member of the community 200—for example, a user who joins the community and wishes merely to view content accessible only to community members may be allowed by the community rule makers to do so without having to join any group 202.

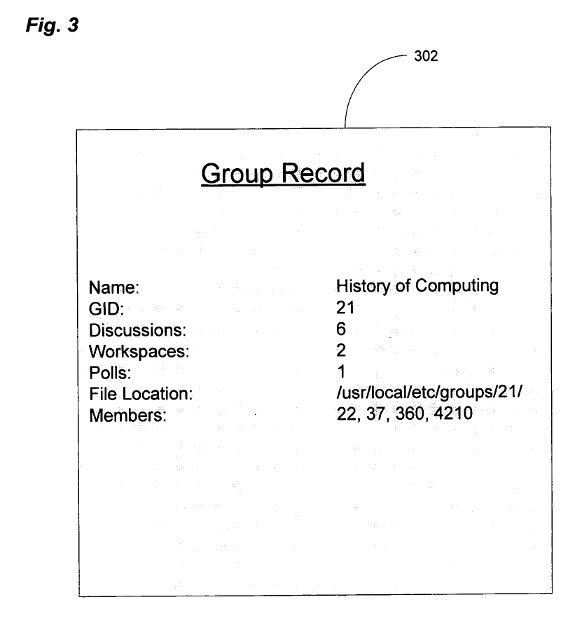

Groups 202 in one embodiment cover broad topics—for example, a group might be titled “Restaurants in San Francisco,” “African Famine,” “The Beatles,” etc. The make-up of a group is further illustrated in FIG. 3. In FIG. 3, each group is identified by a group record 302, which preferably specifies a name of the group; a group ID (GID) number; the number of discussions, workspaces and polls associated with the group; the location of files associated with the group; and the user ID (UID) of the group's members. In the example of FIG. 3, group 302 is named History of Computing and has a GID of 21. The group has 6 associated discussions, 2 workspaces, and 1 poll. Its files are located in the directory /usr/local/groups/21/, and its members have UIDs 22, 37, 360 and 4210.

Each group preferably includes one or more discussions. A discussion is a conversation thread initiated by a member of the group 202, and commented on by any member of the group wishing to speak to the presented issue. Preferably, a cost is associated with the creation of a discussion—for example, 1 bank unit. Similarly, the creation of a group has a cost—preferably a much higher cost than the cost for creating a discussion, which reflects the relative value of a group as being a major category within the community. In one embodiment, for example, creating a group costs 10 bank units.

Groups may also include one or more workspaces. A workspace is a collaborative area in which group members can contribute thoughts and ideas. Unlike a discussion thread, in which each contribution forms a comment in the thread, a workspace allows each contributor to change the content of the workspace, typically allowing others to view not only the final product but also the revisions made along the way. Collaborative workspaces are also known to those of skill in the art as “wikis”.

In one embodiment, groups also include support for polls. A poll is simply a question posed by one member of the group and which includes responses that can be voted on by other members, potentially with an associated cost. Preferably, there is also a cost associated with creating a poll—for example, 1 bank unit.

In one embodiment, members of a group can upload files for use of the other members. As noted, the group record 302 preferably specifies a location for files associated with the group to be stored.

FIG. 4 illustrates an example of a user record 402 in accordance with an embodiment of the present invention. A user record 402 includes a user ID (UID), the user's Name, the user's feedback score, the aggregate feedback score given to comments authored by the user, number of bank units in the user's bank, and the GIDs for the groups of which the user is a member. In the illustrated example, Charles Babbage has UID 4210, a feedback score of +8, 21 bank units, is a member of groups with GID 3, 21, 109 and 221, and has received +4 feedback points from UID 37, −2 feedback points from UID 360, +5 feedback points from UID 3987, and 22 feedback points from UID 22. Tracking the aggregate feedback score given to comments authored by the user provides an indication of how much the user's content contribution is valued by the community at large.

FIG. 5 illustrates an example of an item record 502 in accordance with an embodiment of the present invention. An item record 502 includes a type field, for describing the type of the item, e.g., discussion, workspace, etc.; the UID of the user that created the item; the name of the item; the feedback score of the item; and a list of users from whom feedback has been received. In the illustrated example, “Analytical Machines” is a discussion thread created by UID 4210 (Charles Babbage), and has a feedback score of +2. UIDs 44, 622 and 4 have each given a feedback score of +1, while UID 4901 has offered −1 of feedback.

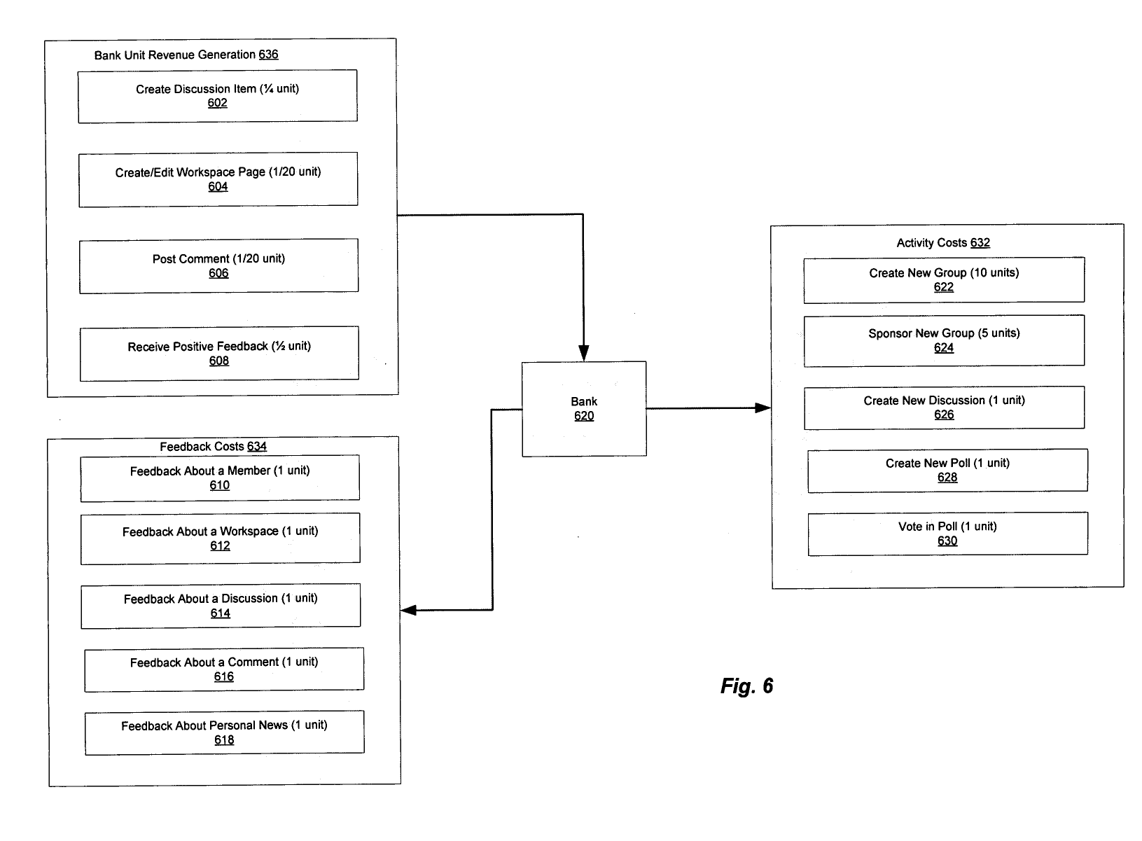

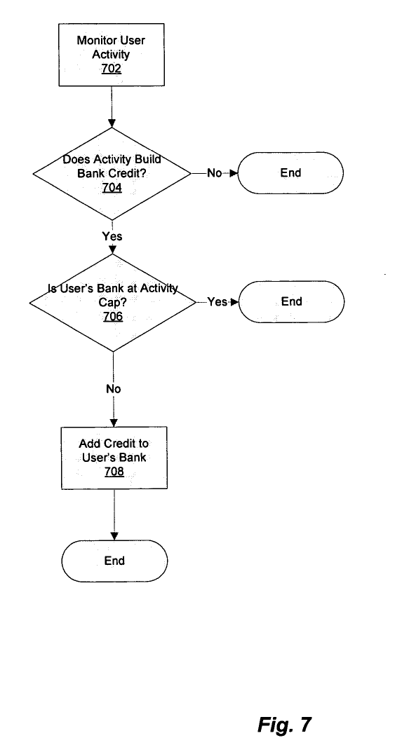

FIG. 6 is a diagram illustrating how bank units are earned and spent in accordance with an embodiment of the present invention. Bank units are earned through a bank unit revenue generation activity 636. In one embodiment, these activities include creation of a discussion item 602, which generates ¼ unit; creating or editing a workspace page 604, which generates 1/20 unit; posting a comment to a discussion thread 606, which generates 1/20 unit; and receiving positive feedback 608, which generates ½ unit. When a user performs any bank unit revenue generation activity, bank unit module 104 increments the user's bank 620, as described further below with respect to FIG. 7. Note that the number of bank units credited based on each activity is variable by community according to the individual preferences of that particular community.

In one embodiment, a member cannot earn more than a maximum amount of bank units by participating in community activities. For example, in one embodiment the number of bank units earnable by a member is three times the member's feedback score. Also, in one embodiment even if a member's bank has reached its activity cap, the member will continue to accrue bank units each time she receives positive feedback from another member. Allowing bank units to accrue from positive feedback while capping growth based on participation reduces the benefit to a user of contributing a large amount of content with very little value to the community.

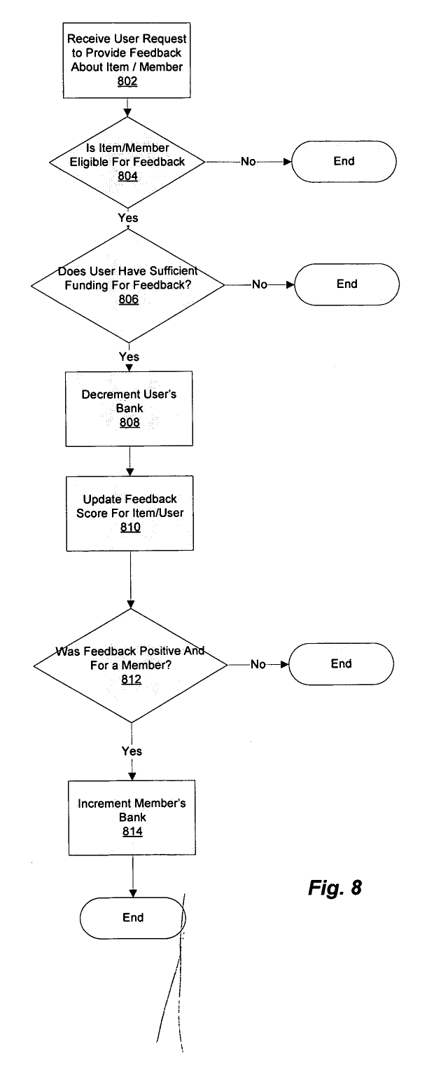

A user of system 100 can also spend bank units by providing feedback about a member or item. FIG. 6 illustrates various feedback costs 634 in accordance with one embodiment. For example, providing feedback about a member 610 costs 1 unit. Similarly, feedback about a workspace 612, a discussion 614, a comment 616 or a user's personal news section 618 each costs 1 bank unit. A process for leaving feedback is described further below with respect to FIG. 8.

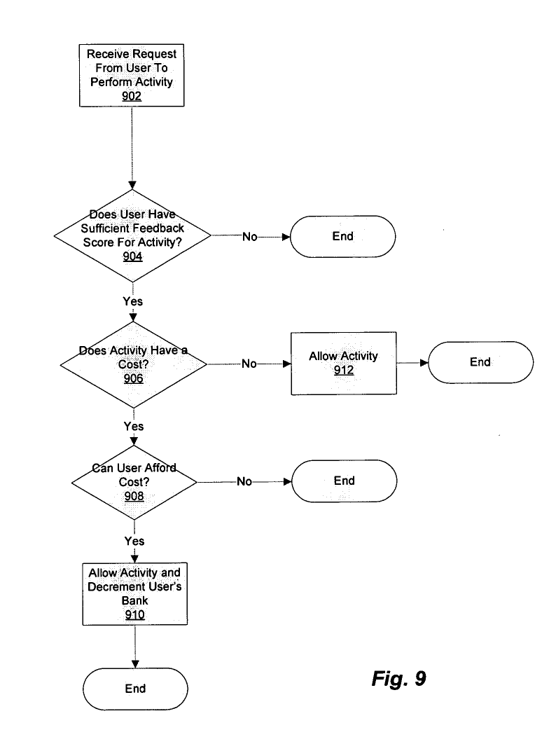

In one embodiment, certain member activities also have associated costs. These activity costs 632 are illustrated in FIG. 6 as well. For example, creating a new group 622 might cost 10 units; sponsoring a new group 624 5 units; creating a new discussion 626 1 unit; creating a new poll 628 1 unit; and voting in a poll 630 1 unit. A method for processing activity costs is illustrated further below with respect to FIG. 9.

FIG. 7 is a flowchart illustrating how credit for activities is added to a user's bank in accordance with an embodiment of the present invention. Feedback engine 102 monitors 702 a user's activity to determine 704 whether it is an activity 636 that generates bank unit credits. If not, the process terminates. If so, then bank unit module 104 determines 706 whether the user's bank is already at a maximum activity cap. If the user's bank is already at the cap, then the process terminates. If not, then bank unit module 104 adds 708 credit to the user's bank 620.

As a user browses the content of the community 200, she encounters items such as workspaces, discussions, contents, groups, and the like. Associated with each of these items of content in the community is a feedback score, evidenced in one embodiment by a score next to a hyperlinked “+|−” symbol. Similarly, next to the name of the author of the content is a similar report of the user's personal feedback score and a hyperlinked “+|−” symbol. If the browsing user wishes to leave feedback for the content author, she clicks the “+” link to provide positive feedback or the “−” link to leave negative feedback. A similar technique is followed to leave feedback about the content itself. In one embodiment, in addition to providing numerical feedback, a user is offered an opportunity to send a message to the member receiving the feedback, either anonymously or with attribution. In one embodiment, a member can view names of people who have offered positive and negative feedback to the member's content or to the member herself. In an alternative embodiment, the member can view names of people who have provided more than a threshold level of feedback, e.g., more than 5 positive or 5 negative score points to the member. Also in an alternative embodiment, the list of people who have provided feedback to the member is viewable by the entire community, not only to the member herself.

FIG. 8 is a flowchart illustrating a process for giving feedback in accordance with an embodiment of the present invention. Initially, feedback engine 102 receives 802 a user request to provide feedback about an item or member. In one embodiment, certain items and members may not be able to receive feedback according to rules established by the community overseers. For example, a rule might specify that a member cannot give herself feedback; or that a new member cannot receive feedback until she has been a member for a certain length of time; or until she has posted a certain number of messages, etc. If the item or member is not capable of receiving feedback, the process terminates. Otherwise, feedback engine 102 next checks 806 to see whether the user has sufficient bank units available with which to leave feedback. If the user does not have sufficient bank units, the process terminates. Otherwise, feedback engine 102 instructs bank unit module 104 to decrement 808 the user's bank, and instructs feedback score module 106 to update 810 the feedback score for the member or item being rated. If 812 the feedback is for an item, then the process terminates. In one embodiment, since receiving positive feedback increases one's own bank, if 812 the user has left positive feedback for a member, feedback engine 102 instructs bank unit module 104 to increment 814 the member's bank as well.

FIG. 9 illustrates a method for processing activity costs in accordance with an embodiment of the present invention. Feedback engine 102 receives 902 a request from a user to perform an activity, such as creating a group or discussion, posting a comment, etc. In one embodiment, a user must have a minimum feedback score in order to perform certain activities, regardless of the units in the user's bank. For example, a community rule in one embodiment requires that a user must have more than a feedback score of −25 in order to create a group. This ensures that users who are highly disliked by the community as represented by their negative feedback scores, are limited in their freedom to participate in the community. Accordingly, if 904 the user does not have a sufficient feedback score to perform the activity requested, the process terminates. Otherwise, feedback engine 102 determines whether 906 the requested activity has a cost. If there is no cost, then feedback engine 102 allows 912 the activity. If there is a cost, then feedback engine 102 determines 908 whether the user can afford the cost by requesting the user's bank unit level from bank unit module 104. If the user cannot afford the cost, the process terminates. If the user can afford the cost, then feedback engine 102 allows 910 the activity and instructs bank unit module 104 to decrement the user's bank by the appropriate number of units.

In an alternative embodiment, bank unit revenue can be generated by activities in addition to or instead of those listed in FIG. 6. For example, reading a discussion, reading a comment, performing a search, creating a poll, voting in a poll and uploading a file could each generate bank unit revenue for a member of the community.

In one embodiment if, after a certain period, e.g., seven days, an item has not been modified—updated, edited or commented upon—feedback engine 102 decays the feedback score for the item at a rate of one point per day, for as long as the item is inactive. Preferably, an item's feedback score will never decay to a score less than zero. Also, in one embodiment comment scores do not decay.

In one embodiment, the number of bank units available to a member is made known to all other members of the community. The member's bank unit size may be displayed in the member's profile page, and additionally may be displayed next to the user's name and feedback score associated with any content published by the user in the community 200.

As will be appreciated by those of skill in the art, by giving positive feedback in accordance with the present invention, members can “bubble up” items of interest to the rest of the community. Conversely, by providing negative feedback, members can reduce the prominence of items.

In one embodiment, if the feedback score of a discussion, comment or workspace turns significantly negative, feedback engine 102 adjusts the prominence of the item to make it less viewable. For example, in one embodiment at a feedback score of −5 an item is folded, and browsing users must affirmatively seek to expand the item before being able to see its content.

Similarly, in one embodiment if the feedback score of a member falls below a threshold amount, that member will lose certain privileges in the community, including the ability to comment or post new items, or send private messages. For example in one embodiment if the user's feedback score falls to −10, all of the user's comments and any discussions she has created are folded, no matter the score of the individual comment. At −25 feedback points, the user loses her voice, except the ability to update the user's own profile area. In one embodiment the user at such a level of feedback can continue to edit comments or discussions she already created, but cannot create new public content, or spend any of her bank units on providing feedback.

The present invention has been described in particular detail with respect to a limited number of embodiments. Those of skill in the art will appreciate that the invention may additionally be practiced in other embodiments. For example, the functionality of the feedback engine can be provided in other embodiments by other modules.

Within this written description, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of feedback engine 102, bank unit module 104 and feedback score module 106 and so forth may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “selecting” or “computing” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

I claim:

1. A method for providing feedback in an online community, the method comprising:
receiving feedback from a first user, the feedback associated with content provided by a second user;
adjusting a feedback score of the second user in accordance with the feedback received from the first user; and
decrementing a number of bank units associated with the first user.

2. The method of claim 1 further comprising:
responsive to the received feedback being negative, lowering the second user's feedback score.

3. The method of claim 2 further comprising reducing the second user's level of access to the community.

4. The method of claim 1 further comprising responsive to the received feedback being positive, increasing the second user's feedback score.

5. The method of claim 4 further comprising increasing the second user's level of access to the community.

6. The method of claim 1 wherein the content provided by the second user includes a discussion thread.

7. A computer program product for providing feedback in an online community, the computer program product stored on a computer-readable medium and including instructions configured to cause a processor to carry out the steps of:
receiving feedback from a first user, the feedback associated with content provided by a second user;
adjusting a feedback score of the second user in accordance with the feedback received from the first user; and
decrementing a number of bank units associated with the first user.

8. A system for providing feedback in an online community, the system comprising:
a feedback engine for receiving feedback from a first user, the feedback associated with content provided by a second user;
a feedback score module, communicatively coupled to the feedback engine, for adjusting a feedback score of the second user in accordance with the feedback received from the first user; and
a bank unit module, communicatively coupled to the feedback engine, for decrementing a number of bank units associated with the first user.
